(19) United States
(12) Patent Application Publication
(10) Pub. No.: US 2026/0114606 A1
(43) Pub. Date: Apr. 30, 2026

(54) PHOTOVOLTAIC PANEL DOUBLE-SIDED WING FOLDING TABLE

(71) Applicant: Jianguang Zhang, RIVERSIDE, CA (US)

(72) Inventor: Jianguang Zhang, RIVERSIDE, CA (US)

(21) Appl. No.: 18/932,571

(22) Filed: Oct. 30, 2024

(51) Int. Cl. A47B 3/083; H02S 30/20

(52) U.S. Cl. CPC A47B 3/083; H02S 30/20

(57) ABSTRACT

A photovoltaic panel double-sided wing folding table is provided, which includes a tabletop, a supporting leg, and a hanging cloth. The end of the tabletop is provided with a solar panel; the bottom of the supporting leg is provided with an extension leg, the surface of the solar panel is provided with a first fastener, the surface of the tabletop is provided with a protrusion, the surface of the supporting leg is provided with a first supporting bracket and a second supporting bracket, the surface of the supporting leg is provided with a snap ring, and the end of the snap ring is provided with a supporting mesh; the end of the supporting mesh is provided with a hanging cloth. The advantageous effect is that the tabletop and the solar panel are hinged through a first rotating shaft.

### TECHNICAL FIELD

The present disclosure relates to the technical field of folding table, in particular to a photovoltaic panel double-sided wing folding table.

### BACKGROUND

A folding table is a table with folding function. Folding tables are generally made of steel and wood structure, which is convenient for folding and transportation;

The existing outdoor folding tables have a single function and are only used for placing items, which cannot meet the electricity needs of users in outdoor environments. Traditional outdoor power equipment is bulky, heavy, inconvenient to carry, and requires additional equipment and space for placement and use.

### SUMMARY

The objective of the present disclosure is to provide a photovoltaic panel double-sided wing folding table to solve the problems raised in the background mentioned above.

To achieve the above objective, the present disclosure provides the following technical solution: a photovoltaic panel double-sided wing folding table, including:
A tabletop, wherein an end of tabletop is provided with a solar panel;
a supporting leg, wherein a bottom of the supporting leg is provided with an extension leg, the surface of the solar panel is provided with a first fastener, a surface of the tabletop is provided with a protrusion, a surface of the supporting leg is provided with a first supporting bracket and a second supporting bracket, the surface of the supporting leg is provided with a snap ring, and an end of the snap ring is provided with a supporting mesh; and
A hanging cloth provided at an end of the supporting mesh.

Preferably, the tabletop and the solar panel are hinged by a first rotating shaft, and the tabletop and the solar panel are capable of being swung along the first rotating shaft, a bottom of the tabletop and the solar panel is fixed with a fixed plate, a surface of the fixed plate is fixed with a first hook part and a second hook part, the first hook part and the second hook part are connected, the first hook part and the second hook part have elasticity, the first hook part and the second hook part (15) are clamped with extension legs, and the extension leg are capable of being removed from the first hook part and the second hook part.

Preferably, the surface of the supporting leg is hinged with an extension plate through a second rotating shaft, the extension plate is capable of being swung along the second rotating shaft, an other end of the first supporting bracket is hinged to the bottom of the tabletop and the solar panel, an other end of the second supporting bracket is hinged to a bottom of the extension plate through a third rotating shaft, and a middle of the first supporting bracket and the second supporting bracket are hinged through a fourth rotating shaft.

Preferably, the end of the tabletop is hinged with a second fastener, the end of the tabletop is fixed with a handle, an end of the solar panel is provided with a protrusion, and the second fastener at the end of the tabletop is capable of being clamped on the surface of the protruding of the end of the solar panel after rotation.

Preferably, the snap ring is clamped on the surface of the supporting leg, the snap ring is capable of being removed from the supporting leg, a surface of the snap ring is fixed with the supporting mesh, the snap ring is provided with four sets, four sets of snap rings are respectively clamped on the surfaces of the four sets of supporting legs, the supporting mesh is located at the bottom of the tabletop and the solar panel.

Preferably, the two ends of the supporting mesh are fixed with a hanging cloth, a surface of the hanging cloth is provided with a pocket, the pocket are located on a side of the hanging cloth away from the supporting mesh.

Preferably, an end of the extension leg is capable of being screwed to an end of the supporting leg, the extension leg is provided with four sets, and the extension leg is screwed to the end of the supporting leg and supported at the bottom of the supporting leg.

Preferably, limited position blocks are respectively arranged on a surface of one section of the first supporting bracket and the second supporting bracket, when the first supporting bracket and the second supporting bracket swing vertically through the fourth rotating shaft, the surface of one end of the first supporting bracket is abuts against a surface of the limited position block of one end of the second supporting bracket, so that the first supporting bracket and the second supporting bracket are stably kept vertical.

Preferably, the surface of the solar panel is provided with an interface, the solar panel is capable of being connected to electrical equipment through wires.

Preferably, cross-shaped supporting rods are provided between the supporting legs, and the support rods are hinged through a fifth rotating shaft.

Compared with the existing technology, the advantageous effects of the present disclosure are:

The tabletop and the solar panel proposed by the present disclosure are hinged through a first rotating shaft. After the tabletop and the solar panel rotate along the first rotating shaft, the tabletop and the solar panel are in the same horizontal plane. By rotating the first fastener, the first fastener is clamped on the surface of the protruding, fixing the tabletop and the solar panel. The tabletop and the solar panel can serve as tops of tables, and the solar panel can be charged by solar energy. By charging the solar panel through the solar energy, the the solar panel can be used as an outdoor power supply. By Swing the supporting leg along the sixth rotating shaft connected to the bottom of the tabletop and the solar panel, the supporting leg is perpendicular to the tabletop and the solar panel, and the supporting leg plays a supporting role. The supporting leg and the bottoms of the tabletop and the solar panel are provided with first supporting brackets, and the first supporting brackets are hinged to each other through a seventh rotating shaft. The first supporting bracket can support on the surface of the supporting leg after being straightened. The surface of the supporting leg is hinged with an extension plate through a second rotating shaft. The extension plate can be extended from the bottom of the tabletop and the solar panel by swinging along the second rotating shaft, and the bottom of the extension plate is provided with a second supporting bracket, which plays a role in supporting the extension plate after being straightened. The bottoms of the tabletop and the solar panel are fixed with a fixed plate, and the surface of the fixed plate is fixed with a first hook part and a second hook part. The extension leg is clamped in the first hook part and the second hook part, and the extension leg can be screwed to the bottom of the supporting leg, increasing the length of the supporting leg. The surface of the supporting leg is clamped with a snap ring, and the end of the snap ring is provided with a supporting mesh. The end of the supporting mesh is provided with a hanging cloth, and the surface of the hanging cloth is provided with a pocket, the surface of the supporting mesh and the interior of the pocket can both accommodate sundries. After combining the tabletop and the solar panel, the second fastener on the surface of the tabletop can be rotated and locked onto the protrusion on the surface of the solar panel, so that the tabletop and the solar panel can be formed into a box. The extension leg, the supporting mesh, and the hanging cloth can be stored inside, and the surface of the tabletop is provided with a handle for easy carrying.

### BRIEF DESCRIPTION OF THE DRAWINGS

FIG. 1 is a schematic diagram of the three-dimensional structure of the present disclosure.

FIG. 2 is a structural diagram from another perspective of the present disclosure.

FIG. 3 is a structural diagram of the bottom of the solar panel of the present disclosure.

FIG. 4 is an enlarged structural diagram of the part A in FIG. 1.

FIG. 5 is an enlarged structural diagram of the part B in FIG. 2.

FIG. 6 is an enlarged structural diagram of the part C in FIG. 3.

FIG. 7 is a structural diagram of the top view of the present disclosure.

### REFERENCE NUMBERS IN THE DRAWINGS

1—tabletop, 2—solar panel, 3—extension plate, 4—supporting leg, 5—extension leg, 6—supporting mesh, 7—pocket, 8—hanging cloth, 10—protrusion, 11—first fastener, 12—first supporting bracket, 13—snap ring, 14—first hook part, 15—second hook part, 16—fixed plate, 17—second fastener, 18—handle, 19—second supporting bracket, 20—output port.

### DETAILED DESCRIPTION OF THE EMBODIMENTS

In order to provide a clear and complete description of the objective and technical solution of the present disclosure, as well as to clarify the advantages, the following embodiments of the present disclosure will be further described in detail in conjunction with the accompanying drawings. It should be understood that the specific embodiments described here are a part of the embodiments of the present disclosure, not all embodiments, and are only used to illustrate the embodiments of the present disclosure, not to limit the embodiments of the present disclosure. All other embodiments obtained by ordinary skilled persons in the art without creative labor are within the scope of the present disclosure.

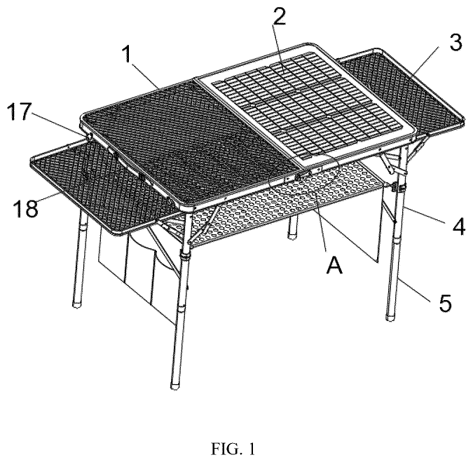

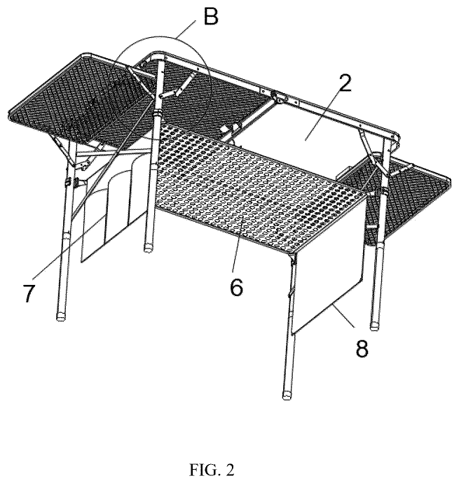

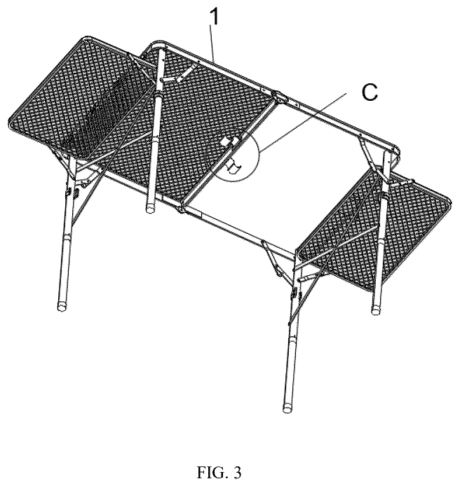

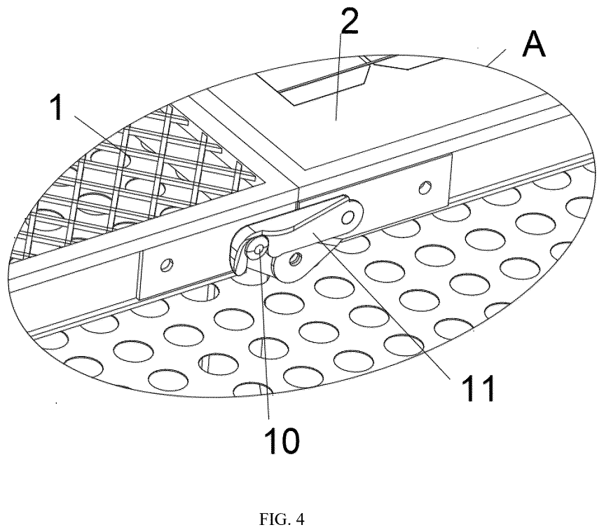

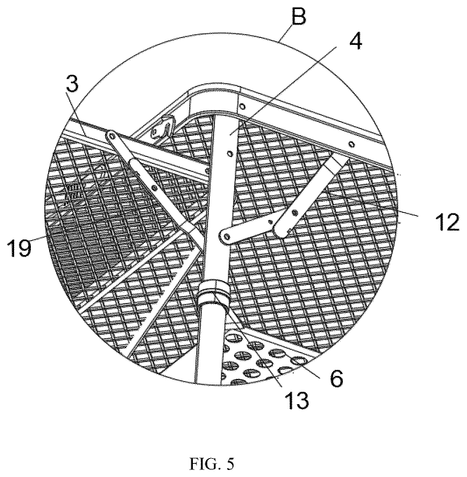

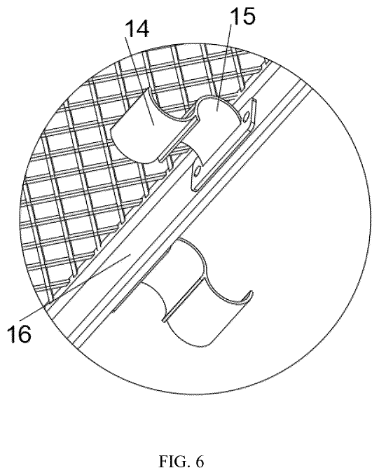

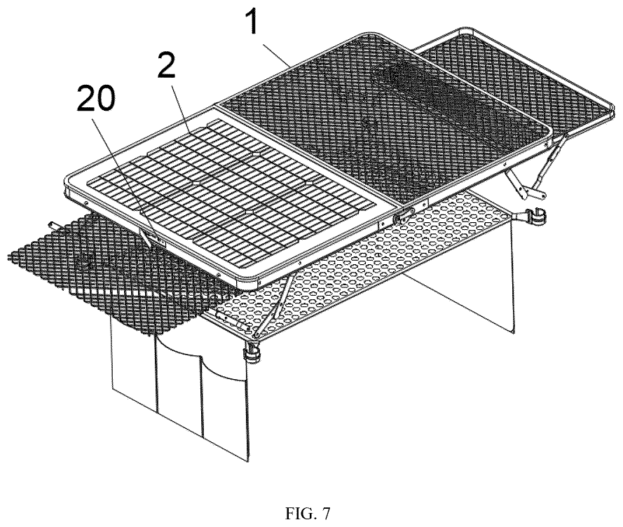

Please refer to FIG. 1 to FIG. 7, the present disclosure provides a technical solution of a photovoltaic panel double-sided wing folding table, which includes:

The end of the tabletop 1 is provided with a solar panel 2, the tabletop 1 and the solar panel 2 are hinged through a first rotating shaft, the tabletop 1 and the solar panel 2 are capable of being swung along the first rotating shaft. The end of the tabletop 1 is hinged with a second fastener 17, and the end of the tabletop 1 is fixed with a handle 18. The end of the solar panel 2 is provided with a protrusion, and the second fastener 17 at the end of the tabletop 1 can be clamped on the protruding surface of the end of the solar panel 2 after rotation. The bottom of the tabletop 1 and the bottom of the solar panel 2 are fixed with a fixed plate 16, and the surface of the fixed plate 16 is fixed with a first hook part 14 and a second hook part 15. The first hook part 14 and the second hook part 15 are connected, and the first hook part 14 and the second hook part 15 have elasticity. The hook part 14 and the second hook part 15 are clamped with an extension leg 5, and the extension leg 5 can be removed from the first hook part 14 and the second hook part 15. The surface of the fixed plate 16 is fixed with the first hook part 14 and the second hook part 15. The first hook part 14 and the second hook part 15 are clamped with the extension leg 5, and the extension leg 5 can be screwed to the bottom of the supporting leg 4 to extend the supporting leg 4.

The bottom of the supporting leg 4 is provided with an extension leg 5, and the end of the extension leg 5 can be screwed onto the end of the supporting leg 4. There are four sets of extension legs 5, and the extension leg 5 supports at the bottom of the supporting leg 4 after the extension leg 5 is screwed onto the end of the supporting leg 4. The surface of the solar panel 2 is provided with a first fastener 11, the surface of the tabletop 1 is provided with a protrusion 10, and the surface of the supporting leg 4 is provided with a first supporting bracket 12 and a second supporting bracket 19. Limited position blocks are respectively arranged on one section of the surface of the first supporting bracket 12 and the second supporting bracket 19. When the first supporting bracket 12 and the second supporting bracket 19 swing vertically through the fourth rotating shaft, the surface of one end of the first supporting bracket 12 is abuts against the surface of limited position block of one end of the second supporting bracket 19, so that the first supporting bracket 12 and the second supporting bracket 19 are stably kept vertical. The surface of the supporting leg 4 is provided with a snap ring 13, which is clamped on the surface of the supporting leg 4 and can be removed from the supporting leg 4, and the surface of the snap ring 13 is fixed with a supporting mesh 6. There are four sets of snap rings 13, the four sets of snap rings 13 are respectively clamped on the surface of the four sets of supporting legs 4. Cross-shaped supporting rods are arranged between the supporting legs 4, and the supporting rods are hinged by a fifth rotating shaft. The supporting mesh 6 is located at the bottom of the tabletop 1 and the solar panel 2, and the end of the snap ring 13 is provided with a supporting mesh 6. The surface of the supporting leg 4 is hinged with an extension plate 3 through a rotating shaft, the extension plate 3 is capable of being swung along the rotating shaft. The other end of the first supporting bracket 12 is hinged to the bottoms of the tabletop 1 and the solar panel 2, and the other end of the second supporting bracket 19 is hinged to the bottom of the extension plate 3 by a third rotating shaft. The middle parts of the first supporting bracket 12 and the second supporting bracket 19 are hinged by a fourth rotating shaft, and the surface of the solar panel 2 is provided with an output port 20, which can be connected to electrical equipment through wires. The first supporting bracket 12 can support on the surface of the supporting leg 4 after being straightened. The surface of the supporting leg 4 is hinged with an extension plate 3 through a second rotating shaft, and the extension plate 3 can be extended from the bottom of the tabletop 1 and the solar panel 2 by swinging along the second rotating shaft. The bottom of the extension plate 3 is provided with a second supporting bracket 19, the second supporting bracket 19 plays a role in supporting the extension plate 3 after being straightened.

A hanging cloth 8 is provided at the end of the supporting mesh 6, the two ends of the supporting mesh 6 are fixed with the hanging cloth 8. A pocket 7 is provided on the surface of the hanging cloth 8, and the pocket 7 is located on the side of the hanging cloth 8 away from the supporting mesh 6. The hanging cloth 8 is provided at the end of the supporting mesh 6, and the pocket 7 is provided on the surface of the hanging cloth 8. Both the surface of the supporting mesh 6 and the interior of the pocket 7 can accommodate sundries.

The tabletop 1 and the solar panel 2 are hinged by a first rotating shaft. The tabletop 1 and the solar panel 2 rotate along the first rotating shaft, so that the tabletop 1 and the solar panel 2 are in the same horizontal plane. The first fastener 11 is rotated so that the first fastener 11 is clamped on the surface of the protrusion 10 to fix the desktop 1 and the solar panel 2. The tabletop 1 and the solar panel 2 can serve as tops of tables, and the solar panel 2 can be charged by solar energy. By charging the solar panel 2 through the solar energy, the solar panel 2 can be used as an outdoor power supply. By swing the supporting leg 4 along the sixth rotating shaft connected to the bottom of the tabletop 1 and the solar panel 2, the supporting leg 4 is perpendicular to the tabletop 1 and the solar panel 2, and the supporting leg 4 plays a supporting role. The supporting leg 4 and the bottoms of the tabletop 1 and the solar panel 2 are provided with first supporting brackets, and the first supporting brackets 12 are hinged to each other through a seventh rotating shaft. The first supporting bracket 12 can support on the surface of the supporting leg 4 after being straightened. The surface of the supporting leg 4 is hinged with the extension plate 3 through a second rotating shaft. The extension plate 3 can be extended from the bottom of the tabletop 1 and the solar panel 2 by swinging along the second rotating shaft, and the bottom of the extension plate 3 is provided with the second supporting bracket 19. The second supporting bracket 19 plays a role in supporting the extension plate 3 after being straightened. The bottom of the tabletop 1 and the solar panel 2 are fixed with the fixed plate 16, and the surface of the fixed plate 16 is fixed with the first hook part 14 and the second hook part 15. The extension leg 5 is clamped in the first hook part 14 and the second hook part 15, and the extension leg 5 can be screwed to the bottom of the supporting leg 4, increasing the length of the supporting leg 4. The surface of the supporting leg 4 is clamped with a snap ring 13, and the end of the snap ring 13 is provided with a supporting mesh 6. The end of the supporting mesh 6 is provided with a hanging cloth 8, and the surface of the hanging cloth 8 is provided with a pocket 7, the surface of the supporting mesh 6 and the interior of the pocket 7 can both accommodate sundries. After combining the tabletop 1 and the solar panel 2, the second fastener 17 on the surface of the tabletop 1 can be rotated and locked onto the protrusion on the surface of the solar panel 2, so that the tabletop 1 and the solar panel 2 can be formed into a box. The extension leg 5, the supporting mesh 6, and the hanging cloth 8 can be stored inside, and the surface of the tabletop 1 is provided with a handle 18 for easy carrying.

Although the specific embodiments of the present application have been described above for the convenience of those skilled in the art to understand the present application, the present application is not limited to the scope of the specific embodiments. For ordinary skilled persons in the art, as long as various changes are within the spirit and scope of the present application as defined and determined by the appended claims, all application creations utilizing the concept of the present application are protected.

1. A photovoltaic panel double-sided wing folding table, comprising:
a tabletop (1), wherein an end of tabletop (1) is provided with a solar panel (2), and a surface of the solar panel (2) is provided with an output port (20);
a supporting leg (4), wherein a bottom of the supporting leg (4) is provided with an extension leg (5), the surface of the solar panel (2) is provided with a first fastener (11), a surface of the tabletop (1) is provided with a protrusion (10), a surface of the supporting leg (4) is provided with a first supporting bracket (12) and a second supporting bracket (19), the surface of the supporting leg (4) is provided with a snap ring (13), and an end of the snap ring (13) is provided with a supporting mesh (6); and
a hanging cloth (8) provided at an end of the supporting mesh (6).

2. The photovoltaic panel double-sided wing folding table according to claim 1, wherein the tabletop (1) and the solar panel (2) are hinged by a first rotating shaft, and the tabletop (1) and the solar panel (2) are capable of being swung along the first rotating shaft, a bottom of the tabletop (1) and the solar panel (2) is fixed with a fixed plate (16), a surface of the fixed plate (16) is fixed with a first hook part (14) and a second hook part (15), the first hook part (14) and the second hook part (15) are connected, the first hook part (14) and the second hook part (15) have elasticity, the first hook part (14) and the second hook part (15) are clamped with the extension leg (5), and the extension leg (5) are capable of being removed from the first hook part (14) and the second hook part (15).

3. The photovoltaic panel double-sided wing folding table according to claim 2, wherein the surface of the supporting leg (4) is hinged with an extension plate (3) through a second rotating shaft, the extension plate (3) is capable of being swung along the second rotating shaft, an other end of the first supporting bracket (12) is hinged to the bottom of the tabletop (1) and the solar panel (2), an other end of the second supporting bracket (19) is hinged to a bottom of the extension plate (3) through a third rotating shaft, and a middle of the first supporting bracket (12) and the second supporting bracket (19) are hinged through a fourth rotating shaft.

4. The photovoltaic panel double-sided wing folding table according to claim 3, wherein the end of the tabletop (1) is hinged with a second fastener (17), the end of the tabletop (1) is fixed with a handle (18), an end of the solar panel (2) is provided with a protrusion, and the second fastener (17) at the end of the tabletop (1) is capable of being clamped on the surface of the protruding of the end of the solar panel (2) after rotation.

5. The photovoltaic panel double-sided wing folding table according to claim 4, wherein the snap ring (13) is clamped on the surface of the supporting leg (4), the snap ring (13) is capable of being removed from the supporting leg (4), a surface of the snap ring (13) is fixed with the supporting mesh (6), the snap ring (13) is provided with four sets, the four sets of snap rings (13) are respectively clamped on the surfaces of four sets of supporting legs (4), and the supporting mesh (6) is located at the bottom of the tabletop (1) and the bottom of the solar panel (2).

6. The photovoltaic panel double-sided wing folding table according to claim 5, wherein two ends of the supporting mesh (6) are fixed with a hanging cloth (8), a surface of the hanging cloth (8) is provided with a pocket (7), and the pocket (7) are located on a side of the hanging cloth (8) away from the supporting mesh (6).

7. The photovoltaic panel double-sided wing folding table according to claim 6, wherein an end of the extension leg (5) is capable of being screwed to an end of the supporting leg (4), the extension leg (5) is provided with four sets, and the extension leg (5) supports at the bottom of the supporting leg (4) after the extension leg (5) is screwed to the end of the supporting leg (4).

8. The photovoltaic panel double-sided wing folding table according to claim 7, wherein limited position blocks are respectively arranged on a surface of one section of the first supporting bracket (12) and a surface of one section of the second supporting bracket (19), when the first supporting bracket (12) and the second supporting bracket (19) swing vertically through the fourth rotating shaft, the surface of one end of the first supporting bracket (12) is abuts against a surface of the limited position block of an end of the second supporting bracket (19), so that the first supporting bracket (12) and the second supporting bracket (19) are stably kept vertical.

9. The photovoltaic panel double-sided wing folding table according to claim 8, wherein the surface of the solar panel (2) is provided with an interface, the solar panel (2) is capable of being connected to electrical equipment through wires.

10. The photovoltaic panel double-sided wing folding table according to claim 9, wherein cross-shaped supporting rods are provided between the supporting legs (4), and the support rods are hinged through a fifth rotating shaft.
